(19) United States
(12) Patent Application Publication
(10) Pub. No.: US 2019/0211730 A1
(43) Pub. Date: Jul. 11, 2019

(54) Method For Producing A Honeycomb Body

(71) Applicant: CONTINENTAL AUTOMOTIVE GmbH, Hannover (DE)

(72) Inventors: Carsten KRUSE, Troisdorf (DE); Peter HIRTH, Rösrath (DE); Frank BOHNE, Sülzetal (DE); Christian SCHORN, Lohmar (DE)

(73) Assignee: CONTINENTAL AUTOMOTIVE GmbH, Hannover (DE)

(21) Appl. No.: 16/333,930

(22) PCT Filed: Sep. 11, 2017
(86) PCT No.: PCT/EP2017/072752

§ 371 Date: Mar. 15, 2019

(30) Foreign Application Priority Data
Sep. 16, 2016 (DE) 10 2016 217 787.7

(51) Int. Cl. F01N 3/28; B01J 35/04

(52) U.S. Cl. CPC F01N 3/281; B01J 35/04; F01N 2330/60; F01N 2330/321; F01N 2330/48; F01N 2330/04

(57) ABSTRACT

A method for producing a honeycomb body having a housing and a honeycomb structure with a multiplicity of channels includes: providing a smooth metal sheet, forming a structure into regions of the smooth metal sheet, the structure in one longitudinal portion is formed differently than a structure in a second longitudinal portion of the metal sheet, forming the honeycomb structure by arranging and winding the structured metal sheet, such that a first cell density in an inner radial zone is increased in relation to a second cell density in an outer radial zone, inserting the honeycomb structure into the housing and, connecting the honeycomb structure to the housing.

### CROSS-REFERENCE TO RELATED APPLICATIONS

This is a U.S. national stage of application No. PCT/EP2017/072752, filed on Sep. 11, 2017. Priority is claimed on German Application No. DE 10 2016 217 787.7, filed Sep. 16, 2016, the content of which is incorporated herein by reference.

### BACKGROUND OF THE INVENTION

### 1. Field of the Invention

The invention relates to a method for producing a honeycomb body for exhaust-gas aftertreatment. The method serves in particular for producing a honeycomb body that can be implemented or used as a catalytic converter substrate body in exhaust-gas systems of mobile internal combustion engines. A honeycomb body of this type provides in particular a large surface area on which catalytically active material is positioned and brought into contact with the exhaust gas flowing through the honeycomb body. A honeycomb body produced in accordance with the method is used in particular in exhaust-gas purification in motor vehicles.

### 2. Description of the Prior Art

A multiplicity of different designs of honeycomb bodies for exhaust-gas aftertreatment are known. A basic distinction is made between ceramic and metal honeycomb bodies. Owing to the simpler production process and the smaller wall thicknesses and thus the possibility of providing a larger surface area per unit of volume, metallic honeycomb bodies in particular have lent themselves to use for the objective set out in the introduction. A honeycomb body of this type may be constructed with smooth and/or structured metallic layers or sheet-metal foils. The metallic layers may be layered, wound and/or coiled and finally positioned in a housing of the honeycomb body, such that a multiplicity of channels through which the exhaust gas can flow are formed. Here, the channels may for example extend in rectilinear, wound and/or oblique form between the end sides of a honeycomb body of said type.

With the aim of obtaining the most intimate possible contact between the exhaust gas and the walls of the honeycomb body, or the catalytic coating located there, measures have already been proposed that reduce a laminar flow of the exhaust gas through the honeycomb body. For example, openings may be provided in the channel walls, such that intercommunicating channels are formed. It is likewise known for diverting structures, guide vanes etc. to be provided in the channels to achieve targeted flow diversion in the channels, pressure differences between the channels, or the like. Here, it must however be taken into consideration that, with an intensified diversion of the exhaust-gas flow within the honeycomb body, a pressure loss across the honeycomb body may also be increased. This may lead to internal combustion engine power losses, because the back pressure can hinder the discharge of exhaust gas from the internal combustion engine.

In the field of automobile construction in particular, further demands are placed on a honeycomb body of this type, or on the production thereof. The focus is in particular on making the production process as inexpensive and simple as possible. Furthermore, it must also be taken into consideration that a honeycomb body of this type is subject to considerable thermal and/or dynamic load fluctuations in a mobile exhaust system, such that, here, it is also the case that particularly high demands are placed on the durability of a honeycomb body of this type under said conditions.

Furthermore, in particular in certain regions of use of a honeycomb body, for example if said honeycomb body is arranged downstream of a diversion in the exhaust-gas tract and/or downstream of a bend in the exhaust-gas line, an inhomogeneous or non-uniform incident flow on the honeycomb body is unavoidable, or can be avoided only with relatively great outlay. This generally has the effect that such a honeycomb body cannot be flowed through in a uniform manner, such that the honeycomb body cannot be ideally utilized. For example, in the case of such an inhomogeneous incident flow, a purification action of the honeycomb body may be reduced, in particular because a catalytic coating that may be provided cannot be brought fully and/or ideally into contact with the exhaust gas, and/or individual or multiple channels of the honeycomb body which are configured with a separation function may not be adequately flowed through.

### SUMMARY OF THE INVENTION

It is an object of one aspect of the present invention to at least partially solve the problems highlighted with regard to the prior art. In particular, it is sought to specify a method for producing a honeycomb body for exhaust-gas aftertreatment, which, in particular even in adverse installation situations in an exhaust system, permits the most uniform possible, or more uniform, throughflow of the honeycomb body. It is furthermore the intention for the method to be implementable as easily and inexpensively as possible.

It should be pointed out that the features specified individually in the dependent patent claims may be combined with one another in any desired technologically meaningful way and define further embodiments of the invention. Furthermore, the features specified in the patent claims are rendered more precisely and explained in more detail in the description, with further preferred configurations of the invention being presented.

A method for producing a honeycomb body for exhaust-gas aftertreatment is proposed, wherein the honeycomb body has at least one housing and a honeycomb structure with a multiplicity of channels (through which flow can pass), wherein a (or at least one specific) cross section of the honeycomb structure has radial zones, and wherein the method comprises at least the following steps:

a) providing at least one smooth metal sheet,

b) forming a structure into at least partial regions of the at least one smooth metal sheet, wherein the structure in at least one first longitudinal portion of the metal sheet is formed differently to the structure in at least one second longitudinal portion of the metal sheet,

c) forming the honeycomb structure by arranging and winding the at least one at least partially structured metal sheet, wherein the metal sheet is arranged and wound such that a first cell density in an inner radial zone is increased in relation to a second cell density in an outer radial zone,

d) inserting the honeycomb structure into the housing,

e) connecting the honeycomb structure to the housing (2).

The method serves in particular for producing a honeycomb body for the aftertreatment of an exhaust gas of an internal combustion engine of a motor vehicle. The indicated sequence of the method steps arises during a normal execution of the method. Individual or all method steps may be performed at the same time, in succession, and/or at least partially in parallel. A honeycomb body produced in accordance with the method has in particular a radially varying/different or variable/changeable flow resistance. The proposed method makes it possible in an advantageous manner to produce a honeycomb body for exhaust-gas aftertreatment, which, in particular even in adverse installation situations of the honeycomb body in an exhaust system, permits a uniform, or more uniform, throughflow of the honeycomb body. This is achieved in particular in that the flow resistance of the honeycomb body is (targetedly) reduced in the outer radial zone owing to the relatively low cell density. Despite the production of the honeycomb structure with radial zones of different cell density, the honeycomb body is advantageously relatively simple and inexpensive to produce, in particular because the different cell densities can be set (exclusively) by the design of the structure of the metal sheet which varies in the longitudinal direction of the metal sheet. Furthermore, it is possible for existing tools to be used for producing the honeycomb body, because it is possible there in particular for the winding process for winding layer packs to be adapted in a technically simple manner.

A honeycomb body produced in accordance with the method may basically take different forms, in particular a circular, oval, polygonal, or similar cross section. A honeycomb body of said type is often formed with a tubular housing. Here, during operation, the exhaust gas generally enters via a first end side of the honeycomb body and exits again via a second end side of the honeycomb body. The end sides, which are preferably arranged substantially parallel to one another, generally define the axial length of the honeycomb body in the direction of a central axis of the honeycomb body, wherein said central axis extends through both end sides and is in particular arranged perpendicularly and centrally with respect to at least one, preferably both end sides.

A or at least one specific cross section of the honeycomb structure of the honeycomb body produced in accordance with the method has radial zones with different cell density. It is possible for multiple cross sections, in particular spaced apart from one another along the central axis and/or in an axial direction, of the honeycomb structure to be formed with radial zones with different cell density. The one or more cross sections of the honeycomb structure under consideration here lie(s) in each case in a cross-sectional plane oriented in particular orthogonally with respect to the central axis of the honeycomb body. The expressions “axial” and “radial” relate here to the central axis of the honeycomb body unless explicitly stated otherwise.

It is preferable for the honeycomb structure, in particular the structure of the metal sheet, to be designed such that, (only) in at least one axial portion of the honeycomb structure, a first cell density in an inner radial zone is increased in relation to a second cell density in an outer radial zone. It is particularly preferable if (for this purpose) the structure (only) in at least one width portion of the metal sheet in at least one first longitudinal portion of the metal sheet is formed differently than the structure in at least one second longitudinal portion of the metal sheet. The structure can be characterized in particular on the basis of a height and a width, wherein, to set the different cell densities, an adapted, that is to say in particular smaller or larger, height and/or width of the structure is generated. It is preferable for multiple axial portions with radial zones of different cell density to be provided so as to be spaced apart from one another in particular along the central axis and/or in an axial direction in the honeycomb structure. It is furthermore preferable for the at least one axial portion to be formed so as to be spaced apart at least from the first end side or from the second end side of the honeycomb body. The radial zones preferably extend along the (entire) axial length of the honeycomb structure.

It is preferable if a ratio of second cell density to first cell density lies in the range from 0.1 to 0.7, particularly preferably in the range from 0.25 to 0.6. It is preferable if the first cell density lies in the range from 300 to 1000 cpsi (cells per square inch), in particular in the range from 400 to 800 cpsi. It is furthermore preferable if the second cell density lies in the range from 100 to 600 cpsi.

It is preferable if multiple outer radial zones, in particular with different cell densities, are provided, wherein the cell densities in the outer radial zones are each smaller than the cell density in the inner radial zone. The outer radial zone(s) is/are in particular arranged so as to at least partially, preferably fully, surround the inner radial zone. The inner radial zone is preferably arranged in the region of and/or around the central axis of the honeycomb body. It is furthermore preferable if the outer radial zone is arranged in the region of the housing or on the housing.

The inner radial zone may be designed differently, in particular with a circular, oval, polygonal or similar cross section. The inner radial zone preferably has a size of at least 50 cm² [square centimeters]. The inner radial zone preferably has a size in the range from 70 to 85 cm². The outer radial zone may have a size of at least 70 cm². The outer radial zone preferably has a size in the range from 90 to 120 cm². It is furthermore preferable if a ratio of an (overall) cross-sectional area of the inner radial zone to an (overall) cross-sectional area of the inner and outer radial zones lies in the range from 0.3 to 0.6, in particular in the range from 0.4 to 0.5. It is preferable if at least the inner radial zone or the outer radial zone is arranged coaxially with respect to the central axis of the honeycomb body. In other words, the inner radial zone is preferably arranged centrally with respect to the cross section of the honeycomb structure.

It is preferable for at least the inner radial zone or the outer radial zone to be arranged at least in a manner dependent on an installation situation of the honeycomb body in an exhaust system or in a manner dependent on an incident-flow profile of an exhaust-gas flow incident on the honeycomb body. In this case, the inner radial zone may be positioned eccentrically with respect to the central axis of the honeycomb body. If the installation situation of the honeycomb body in the exhaust system or in the exhaust line is for example such that the honeycomb body is arranged (directly) downstream of a diversion in the exhaust system and/or downstream of a bend in the exhaust line, then the honeycomb body can be impinged on with a flow profile of the exhaust-gas flow which has a flow profile maximum arranged eccentrically with respect to the central axis of the honeycomb body. The (incident-)flow profile describes the distribution of the flow speed over the (incident-)flow cross section. The (incident-)flow profile maximum lies in particular in the region of the maximum incident-flow speed. It is preferable for the inner radial zone to be arranged centrally with respect to the incident flow on the honeycomb body, in particular centrally with respect to an (incident-)flow profile maximum of the exhaust-gas flow incident on the honeycomb body. It is particularly preferable if the inner radial zone is arranged such that a central region of the inner radial zone spans or overlaps an (incident-)flow profile maximum of the exhaust-gas flow incident on the honeycomb body.

In step a), at least one smooth metal sheet is firstly provided. The metal sheet may be formed with a thickness in the range from 30 to 200 μm [micrometers], and preferably comprises a temperature-resistant, corrosion-resistant material, preferably with relatively high fractions of aluminum, chromium, molybdenum, or constituents of similar action. If the metal sheet that is provided is an “endless” sheet-metal strip, this has, in any case, a longitudinal direction which, in this case, points in particular in the conveying direction in which the sheet-metal strip is to be fed to a processing machine, a (sheet-metal) width, which is in this case understood as an extent of the metal sheet or sheet-metal strip in a width direction oriented transversely with respect to the longitudinal direction, and a (sheet-metal) thickness, which is considerably smaller than the width. If the metal sheet that is provided is (already) a (finite) metal sheet that had been cut, or cut to size, in particular from an (“endless”) sheet-metal strip, then this furthermore has a (sheet-metal) length, which is in this case understood as an extent of the metal sheet in the longitudinal direction. A longitudinal portion of the metal sheet or of the sheet-metal strip is in this case understood in particular as a portion of the metal sheet or of the sheet-metal strip along the longitudinal direction.

In step b), a structure is formed at least partially into the smooth metal sheet provided. Here, the formation of the structure is performed in particular such that at least one at least partially structured metal sheet is formed. This can also be referred to as an at least partially structured metallic layer or foil. The formation of the structure into the metal sheet may be performed such that a (single) metal sheet has smooth and structured portions, or portions with different structuring. The structure of the at least partially structured metal sheet is preferably formed over the entire sheet-metal width of the metal sheet or over the (subsequent) entire axial length of the honeycomb structure, that is to say between the first end side and the second end side. The structure of the at least partially structured metal sheet is in particular formed by elevations and depressions which extend from the first end side to the second end side and which are for example stamped into the metal sheet. In cross section, the elevations and depressions may form a type of sinusoidal corrugation, a zigzag shape or the like. It is preferable if the at least one at least partially structured metal sheet extends over the entire (axial) length of the honeycomb body.

It is preferable if, in step c), the structure is formed differently such that, in particular in a wound state of the metal sheet, there is a greater cell density in the at least one first longitudinal portion than in the at least one second longitudinal portion.

The honeycomb structure preformed in this way can be inserted (possibly with a preload or slight oversize of the cross section) into a (preferably unipartite, tubular) housing.

A soldering or welding process may be used to form a permanent bond of those portions of the at least one metal sheet and/or of the honeycomb body which lie one on top of the other to the housing. A connection is preferably realized by means of a hard soldering process.

In one advantageous embodiment, it is proposed that the formation of the structure in step b) comprises at least the following intermediate steps:

b1.1) forming a primary structure in the at least one first longitudinal portion and in the at least one second longitudinal portion of the metal sheet,

b1.2) forming a secondary structure (only) in the at least one first longitudinal portion of the metal sheet.

Thus, both the primary structure and the secondary structure are present in the at least one first longitudinal portion of the metal sheet. It is preferable if the primary structure has the secondary structure superimposed therewith or thereon in the at least one first longitudinal portion. The steps b1.1) and b1.2) may (in terms of time) be performed in succession, at least partially in parallel, or simultaneously. It is preferable if, despite the formation of the secondary structure, a primary structure width of the primary structure is substantially maintained.

The primary structure is generally characterized by its primary structure width and/or its primary structure height. Furthermore, the secondary structure is generally characterized by its secondary structure width and/or its secondary structure height. Here, a (primary or secondary) structure width is to be understood as the distance between two mutually adjacently arranged extrema, oriented in the same direction, of the structure. If the (primary or secondary) structure is for example an undulation with high points (undulation peaks) and low points (undulation troughs), then the primary or secondary structure width is the distance between two high points or two low points which directly follow one another in the profile of the undulation. Here, a primary or secondary structure height is to be understood as the spacing between two mutually adjacently arranged extrema, oriented in opposite directions, of the structure. If the primary or secondary structure is for example an undulation with high points (undulation peaks) and low points (undulation troughs), then the (primary or secondary) structure height is the spacing between a high point and a low point which directly follow one another in the profile of the undulation. It is preferable if a ratio of secondary structure width to primary structure width lies in the range from 0.2 to 0.8, in particular in the range from 0.4 to 0.6.

The formation of the primary structure, or the deformation of the metal sheet such that a primary structure with a primary structure width and a primary structure height is generated, is preferably performed in continuous fashion. In particular, the manufacturing methods of undulation rolling or roll bending are expedient for producing such a primary structure. In the case of these bending deformation methods, rotating profile rolls are used which can at least partially engage into one another, wherein or while the metal sheet is led through them, in its longitudinal direction. In the case of undulation rolling, the metal sheet is always in contact with the flanks of both intermeshing profile teeth during the deformation process, whereas, in the case of undulation bending, contact on both sides normally occurs only in the region of the profile tooth root or profile tooth tip. Here, in each case, a primary structure is generated whose bending plane is substantially perpendicular to the axis of the rotating tools.

In step b1.2), the metal sheet which has in particular already been at least partially provided with the primary structure, or which is (presently) to be provided with the primary structure, is provided with a secondary structure. It is preferable if, in step b1.2), to form the secondary structure, the first longitudinal portion of the metal sheet is, alternatively or in addition to the profile rolls for forming the primary structure, led through profile rolls, or brought into contact with profile rolls, which are provided and configured specifically for forming the secondary structure. The secondary structure is preferably superimposed on the primary structure, which in other words means in particular that it modifies or eliminates the primary structure in a locally limited manner. For example, it is possible for the primary structure to be at least partially annulled, replaced by another, and/or enhanced. As a distinguishing criterion between primary structure and secondary structure, the location or position thereof on or in the metal sheet may be used. Normally, the primary structure can be easily recognized by viewing that outer edge of the metal sheet that extends parallel to the longitudinal direction of the metal sheet. By contrast, the secondary structure can generally be seen more easily from the maxima (undulation peaks) and minima (undulation troughs), running obliquely, in particular perpendicularly, with respect to the outer edge and/or along a width direction of the metal sheet, of the structure as a modification of the substantially straight-running maxima and minima of the structure, wherein this applies in particular in the case of intermittent, that is to say locally repeating, secondary structures.

In a further advantageous embodiment, it is proposed that the formation of the structure in step b) comprises at least the following intermediate steps:

b2.1) forming a primary structure in the at least one first longitudinal portion and in the at least one second longitudinal portion of the metal sheet,

b2.2) varying, in particular deforming, the formed primary structure in at least the at least one first longitudinal portion or the at least one second longitudinal portion, wherein a primary structure width of the primary structure is at least reduced in the at least one first longitudinal portion or increased in the at least one second longitudinal portion.

For the explanation of step b2.1), reference is made to the statements given regarding step b1.1).

In step b2.2), the metal sheet that has already at least partially been provided with the primary structure, or the primary structure, is reworked, or worked again. In particular, the deformation step in step b2.2) has the result that, in the at least one first longitudinal portion of the metal sheet, a first primary structure width is set, which is smaller than a second primary structure width in the at least one second longitudinal portion. It is preferable if the primary structure in the at least one first longitudinal portion is compressed, shortened, forced closer together, pushed together, or the like. A reduction in size, or reduction, of the primary structure width has the result in particular that the extrema move closer together, wherein the metal sheet regions situated between the extrema fall and rise more steeply. Alternatively or in addition, the primary structure in the at least one second longitudinal portion is pulled (apart), expanded, forced apart, pushed apart or the like. An increase in size of the primary structure width has the result in particular that the extrema move further apart, wherein the metal sheet regions situated between the extrema fall and rise in a shallower manner. It is particularly preferable if a primary structure height of the primary structure in at least the at least one first longitudinal portion and/or the at least one second longitudinal portion remains substantially constant during the variation in step b2).

In a further advantageous embodiment, it is proposed that the formation of the structure in step b) comprises at least the following intermediate steps:

b3.1) forming a primary structure with a first primary structure height in the at least one first longitudinal portion of the metal sheet, and

b3.2) forming a primary structure with a second primary structure height in the at least one second longitudinal portion of the metal sheet,

wherein the second primary structure height is greater than the first primary structure height.

According to this, different primary structures are provided in the at least one first longitudinal portion and in the at least one second longitudinal portion, in particular in succession, at least partially in parallel or simultaneously, wherein the primary structures differ only in terms of their height. It is preferable for the same profile rolls to be used for the formation of the primary structure(s) into the different longitudinal regions. It is furthermore preferable if a shortest spacing between the profile rolls for producing the primary structure is enlarged while the first longitudinal portion of the metal sheet is led through between the profile rolls. In other words, to form the different primary structure heights in the different longitudinal regions, the profile rolls are moved apart or together in targeted fashion.

In step b), the structure may be formed into the metal sheet such that, as viewed in a longitudinal direction of the metal sheet, or along the length of the metal sheet, a second longitudinal portion, a first longitudinal portion and a second longitudinal portion are arranged directly in series. This embodiment is particularly advantageous if, in step a), the metal sheet has already been provided as a smooth metal sheet cut or cut to size from a smooth “endless” sheet-metal strip.

In step a), the at least one smooth metal sheet may be provided as a smooth sheet-metal strip or smooth strip-shaped metal sheet. In this regard, in particular a sheet-metal strip that has undergone substantially no processing by deformation is to be taken as a starting point, which means that said sheet-metal strip is preferably drawn off directly from a coil. In this context, “smooth” means that no structure has yet been formed in, that is to say the sheet-metal strip extends substantially areally. In light of the fact that the method steps for producing multiply structured metal sheets are performed at least predominantly continuously, a sheet-metal strip refers here to a so-called “endless” sheet-metal strip or a so-called “endless” sheet-metal foil, that is to say in particular a metal sheet (in strip form) which does not yet have the dimensions that it ultimately has during its use for example as a substrate body for catalytically active coatings.

In step b), the structure may be formed into the smooth sheet-metal strip such that multiple first longitudinal portions and second longitudinal portions alternate along a longitudinal direction of the sheet-metal strip. First and second longitudinal portions preferably alternate continuously along the longitudinal direction of the sheet-metal strip.

In step b), the structure may be formed into the smooth sheet-metal strip such that the at least one first longitudinal portion and the at least one second longitudinal portion are arranged in each case at a predetermined longitudinal position in a longitudinal direction of the sheet-metal strip and/or of the metal sheet, and each extend over a predetermined length. In particular if the metal sheet is to be wound or coiled in spiral fashion to form the honeycomb body, it is preferable for the longitudinal positions and the lengths of the at least one first longitudinal portion and of the at least one second longitudinal portion to be determined such that, during the winding in spiral form, each first longitudinal portion is arranged in the inner radial zone and each second longitudinal portion is arranged in the outer radial zone of the honeycomb structure. It is furthermore preferable if at least the longitudinal positions or the lengths of the at least one first longitudinal portion and of the at least one second longitudinal portion are determined in a manner dependent on at least the size and/or the (radial) location or position at least of the inner radial zone or of the outer radial zone. Here, at least the size and/or the (radial) location or position at least of the inner radial zone or of the outer radial zone may be determined in a manner dependent on an installation situation of the honeycomb body in an exhaust system or in a manner dependent on an (average, or generally expected) incident-flow profile of an exhaust-gas flow incident on the honeycomb body. In particular if the metal sheet is to be wound or coiled in S-shaped fashion to form the honeycomb body, it is preferable for the longitudinal positions and the lengths of the at least one first longitudinal portion and of the at least one second longitudinal portion to be determined such that the at least one first longitudinal portion is arranged centrally with respect to the length of the metal sheet cut off from the sheet-metal strip.

Cutting of the sheet-metal strip may be performed at a time before the formation of the honeycomb structure. The cutting is performed in particular such that at least one at least partially structured metal sheet is formed or provided, wherein the at least one at least partially structured metal sheet comprises at least one first longitudinal portion and at least one second longitudinal portion, preferably two second longitudinal portions, of the sheet-metal strip.

In step d), the at least one at least partially structured metal sheet may be arranged and wound such that the at least one first longitudinal portion is arranged (only) in the inner radial zone and the at least one second longitudinal portion is arranged (only) in the outer radial zone. For this purpose, the at least one at least partially structured metal sheet may be coiled, wound and/or stacked. For example, the at least one at least partially structured metal sheet may be arranged with one end in the region of the central axis of the honeycomb body and wound in spiral fashion around the central axis. It is furthermore possible for multiple metal sheets to be arranged on top of one another to form a stack, and for example wound in S-shaped fashion.

It is preferable for the at least one at least partially structured metal sheet to be arranged jointly with at least one metallic smooth layer to form at least one stack, which is subsequently wound to form the honeycomb structure. Here, the smooth layer may advantageously prevent adjacent structured metal sheets from sliding into one another in an undesired manner. In particular if no smooth layers are provided, it is, for this purpose basically also possible for the structure to be formed into the metal sheet such that elevations and depressions of the structure run obliquely with respect to a width direction of the metal sheet or obliquely with respect to the central axis of the honeycomb body. In this way, in particular, channels are formed which run not parallel but obliquely with respect to the central axis. This has the effect in particular that the elevations and depressions of the structure lie linearly against one another at least partially and preferably nowhere in the honeycomb body, but rather cross one another and thus form substantially only punctiform abutment points with one another. This can likewise prevent adjacent structured metal sheets from sliding into one another in an undesired manner, even without the presence of a smooth layer. The honeycomb structure is preferably produced with a stack, comprising the at least one at least partially structured metal sheet and at least one metallic smooth layer, which is wound in S-shaped fashion. If multiple stacks are used, these can be arranged adjacent to one another, and wound with one another, as a U-shaped and/or V-shaped arrangement and inserted into a housing. Both configurations normally have in common the fact that all of the ends of the stacks, metal sheets and/or layers are directed to the outside, that is to say bear against a housing, whereas the bends (s, v, u) are positioned at the inside. It is preferably the case that, in the stack, at least partially structured metal sheets and metallic smooth layers are present in alternating fashion, said layers in each case delimiting channels of the honeycomb body. The walls of the channels may be smooth, flat and/or free from fixtures in the profile direction of the channels, and/or may have projections, blades, holes and/or diverting surfaces for the exhaust gas. It is preferable if, in step e), the connection is performed by means of a thermal joining process, in particular by a welding process or a (hard) soldering process.

Also proposed is a motor vehicle, having an internal combustion engine with an exhaust system, wherein the exhaust system has at least one catalytic converter substrate or a particle separator that is formed with a honeycomb body produced in accordance with a method described here. Here, the catalytic converter substrate and/or the particle separator may have a catalytically active coating, which may if appropriate also be configured differently in axial sub-sections of the honeycomb body.

### BRIEF DESCRIPTION OF THE DRAWINGS

The invention and the technical field will be explained in more detail below on the basis of the figures. It is pointed out that the invention is not to be restricted by the exemplary embodiments presented. In particular, unless explicitly indicated otherwise, it is also possible to extract partial aspects of the substantive matter explained in the figures and combine these with other constituents and/or knowledge from other figures and/or from the present description. In the figures, in each case schematically:

FIG. 1 is a cross section through a honeycomb body produced in accordance with a method described here;

FIG. 2 is a cross section through a metal sheet into which a structure has been formed;

FIG. 3 is a cross section through a further metal sheet into which a structure has been formed; and

FIG. 4 is a cross section through a further metal sheet into which a structure has been formed.

### DETAILED DESCRIPTION OF THE PRESENTLY PREFERRED EMBODIMENTS

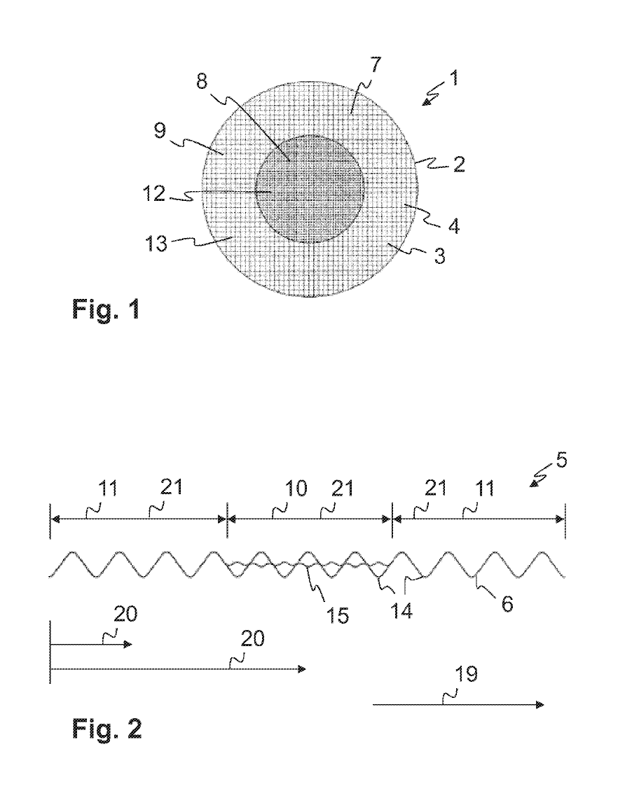

FIG. 1 schematically shows a cross section through a honeycomb body 1 for exhaust-gas aftertreatment produced in accordance with a method described here. The honeycomb body 1 has a housing 2 and a honeycomb structure 3 with a multiplicity of channels 4. It is illustrated in FIG. 1 that a cross section 7 of the honeycomb structure 3 has radial zones 8, 9, which are of different design. Here, a first cell density 12 in an inner radial zone 8 is increased in relation to a second cell density 13 in an outer radial zone 9.

FIG. 2 schematically shows a cross section through a metal sheet 5 into which a structure 6 has been formed. As per the illustration in FIG. 2, the structure 6 in a first longitudinal portion 10 of the metal sheet 5 has been formed differently to the structure 6 in two second longitudinal portions 11 of the metal sheet 5. For this purpose, a primary structure 14 has been formed in the first longitudinal portion 10 and in the second longitudinal portions 11 of the metal sheet 5. Furthermore, a secondary structure 15 has been formed only in the first longitudinal portion 10 of the metal sheet 5. It can be seen in FIG. 2 that the secondary structure 15 in the first longitudinal portion 10 has the local primary structure 14 superimposed thereon. As per the illustration in FIG. 2, the secondary structure 15 has the effect that the cell density is virtually doubled in the first longitudinal portion 10.

It is also shown in FIG. 2 that the structure 6 has been formed into the metal sheet 5 such that, as viewed in a longitudinal direction 19 of the metal sheet 5, a second longitudinal portion 11, a first longitudinal portion 10 and a second longitudinal portion 11 are arranged (directly) in series. Furthermore, the structure 6 has been formed in such that the first longitudinal portion 10 and the second longitudinal portions 11 are arranged in each case at a predetermined longitudinal position 20 in a longitudinal direction 19 and each extend over a predetermined length 21.

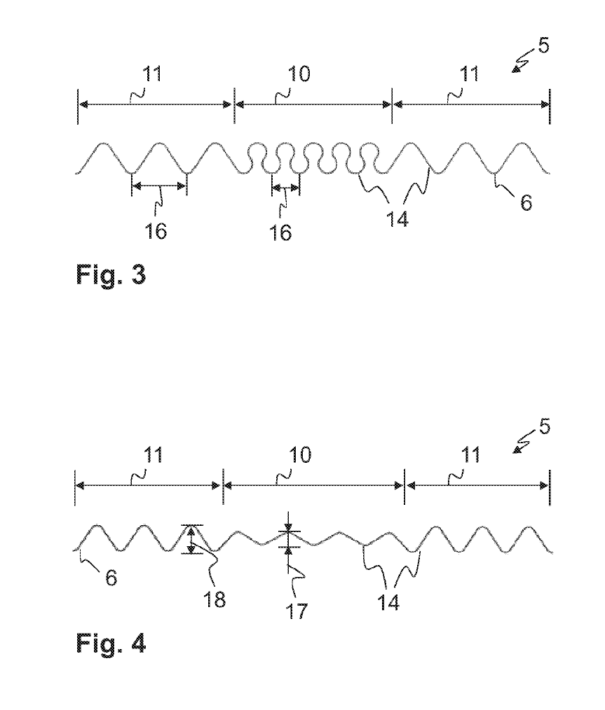

FIG. 3 schematically shows a cross section through a further metal sheet 5 into which a structure 6 has been formed. The structure 6 in a first longitudinal portion 10 of the metal sheet 5 has been formed differently to the structure 6 in two second longitudinal portions 11 of the metal sheet 5. For this purpose, a primary structure 14 has been formed in the first longitudinal portion 10 and in the second longitudinal portions 11 of the metal sheet 5. The primary structure 14 formed in the first longitudinal portion 10 has been altered or deformed such that a primary structure width 16 of the primary structure 14 in the first longitudinal portion 10 has been reduced in relation to the primary structure width 16 of the primary structure 14 in the second longitudinal portions 11. The alteration or deformation illustrated in FIG. 3 of the primary structure width 16 of the primary structure 14 in the first longitudinal portion 10 is also referred to as gathering.

FIG. 4 schematically shows a cross section through a further metal sheet 5 into which a structure 6 has been formed. The structure 6 in a first longitudinal portion 10 of the metal sheet 5 has been formed differently to the structure 6 in two second longitudinal portions 11 of the metal sheet 5. For this purpose, a primary structure 14 with a first primary structure height 17 has been formed in the first longitudinal portion 10 of the metal sheet 5 and a primary structure 14 with a second primary structure height 18 has been formed in the second longitudinal portions 11. Here, the second primary structure height 18 is greater than the first primary structure height 17.

If multiple metal sheets 5, which are each designed in accordance with the design variant as per FIG. 2, FIG. 3 or FIG. 4, are arranged one above the other or so as to form a stack and wound, for example in S-shaped fashion to form a honeycomb structure 3 as shown in the cross section in FIG. 1, then the first longitudinal portion 10 of each metal sheet 5 is arranged preferably only in the inner radial zone 8 and the second longitudinal portions 11 are arranged preferably only in the outer radial zone 9 of the honeycomb structure 3. Such an arrangement and winding of the metal sheets 5 each designed in accordance with the design variant as per FIG. 2, FIG. 3 or FIG. 4 has the effect that the first cell density 12 in the inner radial zone 8 is greater than the second cell density 13 in the outer radial zone 9. Owing to the increased cell density, the inner radial zone 8 has a greater flow resistance, such that a possibly non-uniform exhaust-gas flow incident on the honeycomb structure 3 is more inclined to flow through the outer radial zone 9. It is thus possible to achieve a more uniform throughflow of the honeycomb structure 3, which generally contributes to more efficient utilization of the possibly provided catalytic and/or separation function of the honeycomb structure 3.

Here, a method for producing a honeycomb body for exhaust-gas aftertreatment is specified which at least partially solves the problems highlighted with regard to the prior art. In particular, the method permits the production of a honeycomb body which, in particular even in adverse installation situations in an exhaust system, permits the most uniform possible, or more uniform, throughflow of the honeycomb body. The method can furthermore be implemented in the most simple and inexpensive manner possible.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A method for producing a honeycomb body for exhaust-gas aftertreatment, comprising:
providing at least one smooth metal sheet;
forming structures into at least partial regions of the at least one smooth metal sheet, wherein a first structure in at least one first longitudinal portion of the metal sheet is formed differently than a second structure in at least one second longitudinal portion of the metal sheet;
forming a honeycomb structure with a multiplicity of channels by arranging and winding the at least one partially structured metal sheet, wherein the metal sheet is arranged and wound such that a cross section of the honeycomb structure has a first cell density in an inner radial zone that is increased in relation to a second cell density in an outer radial zone;
inserting the honeycomb structure into a housing; and
connecting the honeycomb structure to the housing.

12. The method as claimed in claim 11, wherein the forming of the structures comprises:
forming a primary structure in the at least one first longitudinal portion and in the at least one second longitudinal portion of the metal sheet; and
forming a secondary structure in the at least one first longitudinal portion of the metal sheet.

13. The method as claimed in claim 11, wherein the forming of the structures comprises:
forming a primary structure in the at least one first longitudinal portion and in the at least one second longitudinal portion of the metal sheet; and
varying the formed primary structure in at least the at least one first longitudinal portion or the at least one second longitudinal portion,
wherein a primary width of the primary structure is at least reduced in the at least one first longitudinal portion or increased in the at least one second longitudinal portion.

14. The method as claimed in claim 11, wherein the forming of the structures comprises:
forming a primary structure with a first primary structure height in the at least one first longitudinal portion of the metal sheet; and
forming the primary structure with a second primary structure height in the at least one second longitudinal portion of the metal sheet,
wherein the second primary structure height is greater than the first primary structure height.

15. The method as claimed in claim 11, wherein, the structures are formed into the metal sheet such that, as viewed in a longitudinal direction of the metal sheet, the first longitudinal portion and the second longitudinal portion are arranged in series.

16. The method as claimed in claim 11, wherein the at least one smooth metal sheet is provided as a smooth sheet-metal strip.

17. The method as claimed in claim 16, wherein the structures are formed into the smooth sheet-metal strip such that multiple first longitudinal portions and second longitudinal portions repeatedly alternate along a longitudinal direction of the sheet-metal strip.

18. The method as claimed in claim 16, wherein, the structures are formed into the smooth sheet-metal strip such that the at least one first longitudinal portion and the at least one second longitudinal portion are arranged in each case at a predetermined longitudinal position in a longitudinal direction of the sheet-metal strip, and each extend over a predetermined length.

19. The method as claimed in claim 16, wherein cutting of the sheet-metal strip is performed prior to formation of the honeycomb structure.

20. The method as claimed in claim 11, wherein the at least one at least partially structured metal sheet is arranged and wound such that the at least one first longitudinal portion is arranged in the inner radial zone and the at least one second longitudinal portion is arranged in the outer radial zone.

21. The method as claimed in claim 17, wherein, the structures are formed into the smooth sheet-metal strip such that the at least one first longitudinal portion and the at least one second longitudinal portion are arranged in each case at a predetermined longitudinal position in a longitudinal direction of the sheet-metal strip, and each extend over a predetermined length.
